(19) United States
(12) Patent Application Publication
(10) Pub. No.: US 2015/0178726 A1
(43) Pub. Date: Jun. 25, 2015

(54) SYSTEM AND METHOD FOR MOBILE PAYMENT AUTHENTICATION

(71) Applicant: Tencent Technology (Shenzhen) Company Limited, Shenzhen (CN)

(72) Inventor: Yutao WEN, Shenzhen (CN)

(21) Appl. No.: 14/460,278

(22) Filed: Aug. 14, 2014

Related U.S. Application Data
(63) Continuation of application No. PCT/CN2014/079234, filed on Jun. 5, 2014.

(30) Foreign Application Priority Data
Dec. 23, 2013 (CN) 201310720111.5

(51) Int. Cl. G06Q 20/40

(52) U.S. Cl. CPC G06Q 20/40

(57) ABSTRACT

A method of authenticating a payment request from a requesting terminal is performed at a computer server having one or more processors and memory storing program modules to be executed by the one or more processors. The computer server receives a payment request from the requesting terminal. If the payment request satisfies predefined authentication conditions, the computer server sends a payment authentication request to an authentication terminal associated with the requesting terminal and receives a response to the payment authentication request from the authentication terminal. The computer server forwards the payment request to a payment server if the response indicates that the payment authentication request succeeds. Otherwise, the computer server notifies the requesting terminal that the payment request is denied if the payment authentication request fails.

### RELATED APPLICATIONS

This application is a continuation application of PCT Patent Application No. PCT/CN2014/079234, entitled “SYSTEM AND METHOD FOR MOBILE PAYMENT AUTHENTICATION” filed on Jun. 5, 2014, which claims priority to Chinese Patent Application No. 201310720111.5, entitled “Method and apparatus for payment authentication,” filed on Dec. 23, 2013, both of which are incorporated by reference in their entirety.

### TECHNICAL FIELD

The disclosed implementations relate generally to the field of the Internet, and in particular, to system and method for mobile payment authentication.

### BACKGROUND

With the rapid development of mobile terminals, mobile payments using mobile terminals have become increasingly frequent. Although mobile payments have brought great convenience, but security problems associated with the mobile payment are also getting worse. Currently, people use short message service (SMS) to communicate authentication codes. When a user makes a payment through a mobile terminal, the payment server sends a text message to the user's mobile terminal for authentication, thereby enhancing the security of the mobile payment. However, if the mobile terminal is lost, it is unable to prevent others from using the mobile terminal to make payments.

### SUMMARY

In accordance with some implementations of the present application, a method of authenticating a payment request from a requesting terminal is performed at a computer server having one or more processors and memory storing program modules to be executed by the one or more processors. The method includes the following steps: receiving a payment request from the requesting terminal; in accordance with determining that the payment request satisfies predefined authentication conditions, sending a payment authentication request to an authentication terminal associated with the requesting terminal; receiving a response to the payment authentication request from the authentication terminal; forwarding the payment request to a payment server if the response indicates that the payment authentication request succeeds; and notifying the requesting terminal that the payment request is denied if the payment authentication request fails.

In accordance with some implementations of the present application, a computer system includes one or more processors; memory; and one or more programs stored in the memory and to be executed by the one or more processors, the program modules including instructions for: receiving a payment request from the requesting terminal; in accordance with determining that the payment request satisfies predefined authentication conditions, sending a payment authentication request to an authentication terminal associated with the requesting terminal; receiving a response to the payment authentication request from the authentication terminal; forwarding the payment request to a payment server if the response indicates that the payment authentication request succeeds; and notifying the requesting terminal that the payment request is denied if the payment authentication request fails.

In accordance with some implementations of the present application, a non-transitory computer readable storage medium stores one or more program modules configured for execution by a computer system that includes one or more processors and memory storing one or more program modules, the program modules including instructions for: receiving a payment request from the requesting terminal; in accordance with determining that the payment request satisfies predefined authentication conditions, sending a payment authentication request to an authentication terminal associated with the requesting terminal; receiving a response to the payment authentication request from the authentication terminal; forwarding the payment request to a payment server if the response indicates that the payment authentication request succeeds; and notifying the requesting terminal that the payment request is denied if the payment authentication request fails.

### BRIEF DESCRIPTION OF DRAWINGS

The aforementioned implementation of the present application as well as additional implementations will be more clearly understood as a result of the following detailed description of the various aspects of the present application when taken in conjunction with the drawings. Like reference numerals refer to corresponding parts throughout the several views of the drawings.

FIG. 1 is a flow diagram of mobile payment according to a first embodiment of the present application;

FIG. 2A is an exemplary user interface of a mobile terminal prior to making the payment request;

FIG. 2B is an exemplary user interface of the mobile terminal when making the payment request;

FIG. 3 is an exemplary user interface of the mobile terminal when the mobile payment authentication fails;

FIG. 4 is a flow diagram of mobile payment according to a second embodiment of the present application;

FIG. 5A is an exemplary user interface of the mobile terminal when making the payment completion request;

FIG. 5B is an exemplary user interface of the mobile terminal after making the payment completion request;

FIG. 6 is a flow diagram of mobile payment according to a third embodiment of the present application;

FIG. 7A is an exemplary user interface of the mobile terminal when making the payment card binding request;

FIG. 7B is an exemplary user interface of the mobile terminal after making the payment card binding request;

FIG. 7C is an exemplary user interface of the mobile terminal when adding the payment authentication entity;

FIG. 8 is an exemplary user interface of the mobile terminal when the payment card binding request fails;

FIG. 9 is a flow diagram of mobile payment according to a fourth embodiment of the present application;

FIG. 10A is an exemplary user interface of the mobile terminal before updating the payment authentication entity;

FIG. 10B is an exemplary user interface of the mobile terminal when updating the payment authentication entity;

FIG. 11 is a block diagram of a mobile terminal performing the payment authentication according to the first embodiment of the present application;

FIG. 12 is a block diagram of a mobile terminal performing the payment authentication according to the second embodiment of the present application;

FIG. 13 is a block diagram of a payment authentication server;

FIG. 14 is a flow diagram of mobile payment according to a fifth embodiment of the present application;

FIGS. 15A and 15B are exemplary user interfaces of the mobile terminal when the mobile payment succeeds;

FIG. 16 is a flow diagram of mobile payment according to a sixth embodiment of the present application;

FIG. 17 is a flow diagram of mobile payment according to a seventh embodiment of the present application;

FIG. 18 is a flow diagram of mobile payment according to an eighth embodiment of the present application; and

FIG. 19 is a schematic diagram of the network environment involving mobile terminals and servers.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

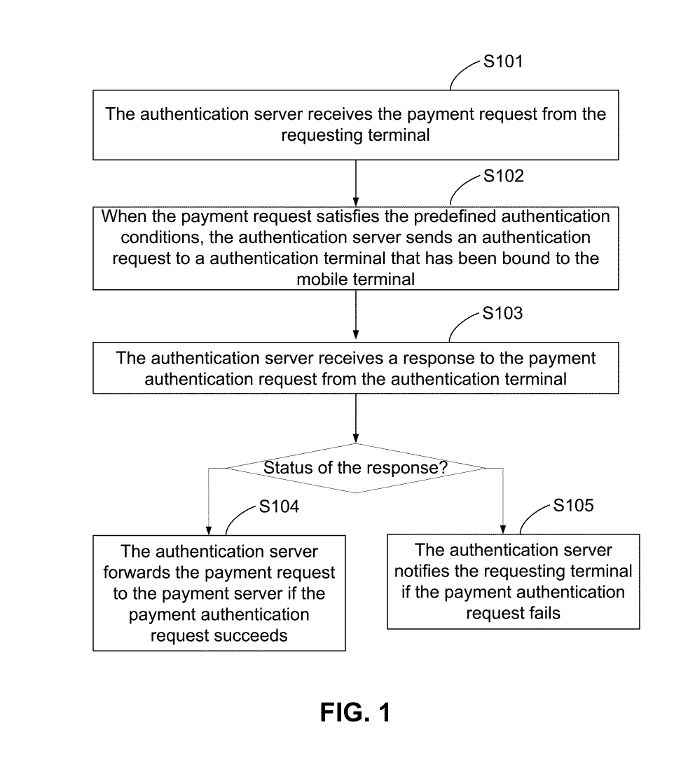

The present application proposes a method of an authentication server processing mobile payment authentication request from a mobile terminal. As shown in FIG. 1, the method comprises the following steps:

Step S101, the authentication server receives the payment request from the requesting terminal.

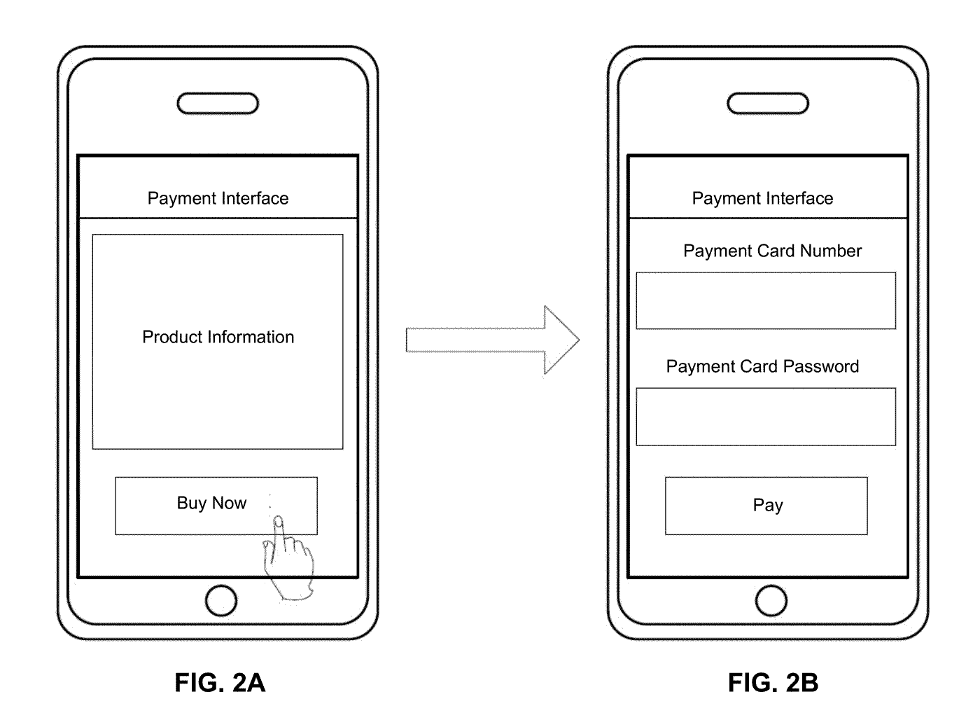

The payment request includes payment information, such as product information, payment amount, the source of goods and bank account information, payment password and so on. When a user purchases a product through a mobile terminal while browsing the product on the mobile terminal, he can click on the “Buy Now” icon as shown in FIG. 2A and enter the user interface shown in FIG. 2B. The interface asks the user to enter the bank card number and the payment password. When users enters the card number and payment password, the user then clicks the “Pay” icon, which triggers a payment request. Note that the product for sale is not only tangible products, but also intangible products, such as prepaid services, coupon services. In some embodiments, the payment request also includes the current location of the requesting terminal, the timestamp at which the payment request was generated, etc.

Step S102, when the payment request satisfies the predefined authentication conditions, the authentication server sends a payment authentication request to an authentication terminal that has been bound to the mobile terminal.

Upon receiving the payment request sent by the requesting terminal, the server determines whether the payment request satisfies predefined authentication conditions. For example, the authentication condition may be that when the payment amount exceeds a predetermined threshold (e.g., $1000), there is a need for authentication. Therefore, if the amount of the payment is $1100, the predefined condition is met and the payment needs to be verified and the server will send the payment authentication request to the authentication terminal that has been bound to the mobile terminal. Other authentication conditions include that the total amount of payment initiated by the requesting terminal exceeds a predefined limit within a predefined time window, the requesting terminal makes the payment request at a location outside a predefined location range, the product being purchased is one from a predefined list of products, the time difference between the previous payment request and the current payment request is longer than a predefined threshold, etc. In some embodiments, the payment authentication request includes information of the requesting terminal (e.g., the phone number of the requesting terminal if it is a smartphone) and payment details, such as product information and the amount to be paid, etc.

Step S103, the authentication server receives a response to the payment authentication request from the authentication terminal. The response indicates whether the payment authentication request succeeds or fails.

Step S104, the authentication server forwards the payment request to the payment server if the payment authentication request succeeds.

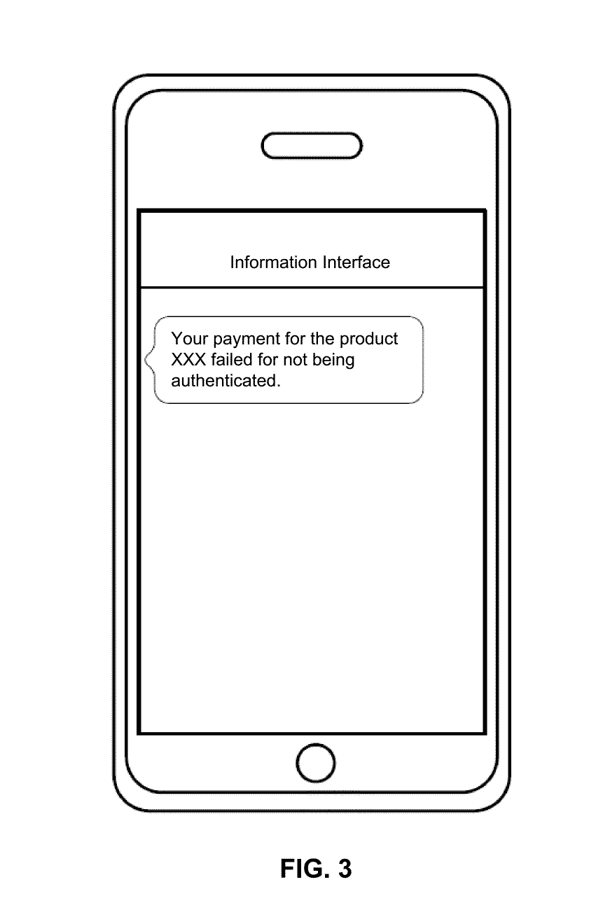

Step S105, the authentication server notifies the requesting terminal if the payment authentication request fails. As shown in FIG. 3, the requesting terminal displays a message indicating that the payment authentication request fails. The requesting terminal may subsequently initiate a new payment authentication request.

In sum, the authentication server sends a payment authentication request to an authentication terminal that has been bound to the requesting terminal previously upon receipt of a payment request that meets predefined conditions. The server forwards the payment request to the payment server only after the payment authentication request succeeds at the authentication terminal and rejects the payment request if otherwise. By doing so, the authentication server can prevent a lost mobile terminal from being used by somebody else for making unauthorized payments and enhance the safety of mobile payments.

In some embodiments, a commercial transaction of purchasing a product has a corresponding payment time window. For example, it should take less than 24 hours from submitting an order to payment completion. Therefore, the authentication server may also determine whether the payment authentication request succeeds based on whether the response from the authentication terminal arrives within the time window. If not, the server will notify the requesting terminal that the payment authentication request failed.

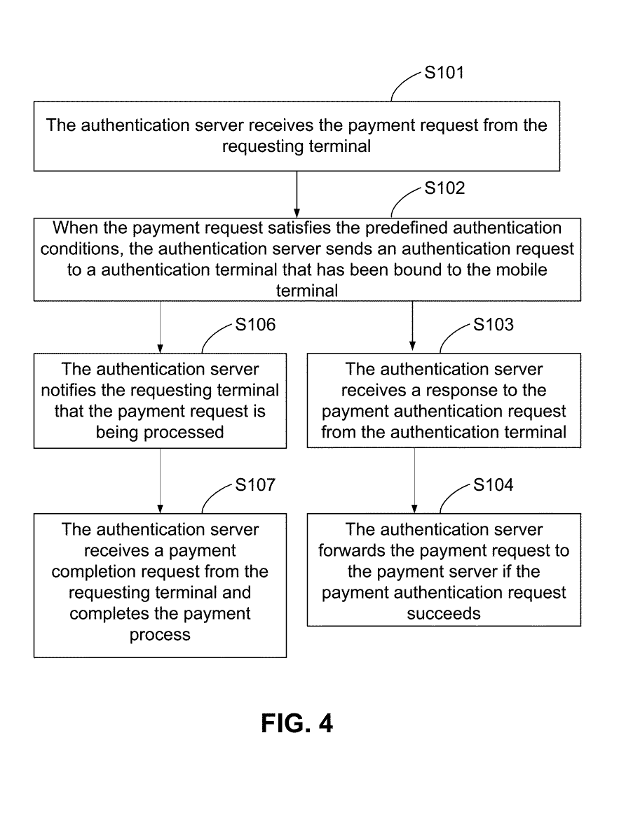

FIG. 4 depicts a second embodiment of mobile payment authentication. In this embodiment, there are additional steps after step S102 in FIG. 1:

Step S106, the authentication server notifies the requesting terminal that the payment request is being processed.

Step S107, the authentication server receives a payment completion request from the requesting terminal, completes the payment process, and causes the requesting terminal to quit the payment request user interface. In some embodiments, the authentication server receives the payment completion request from the requesting terminal before the authentication server receives the response from the authentication server at step S103. But as explained below, this payment completion request does not guarantee that the payment request will be completed by the authentication server or the payment server if the requesting terminal fails to satisfy other conditions defined by the payment authentication process.

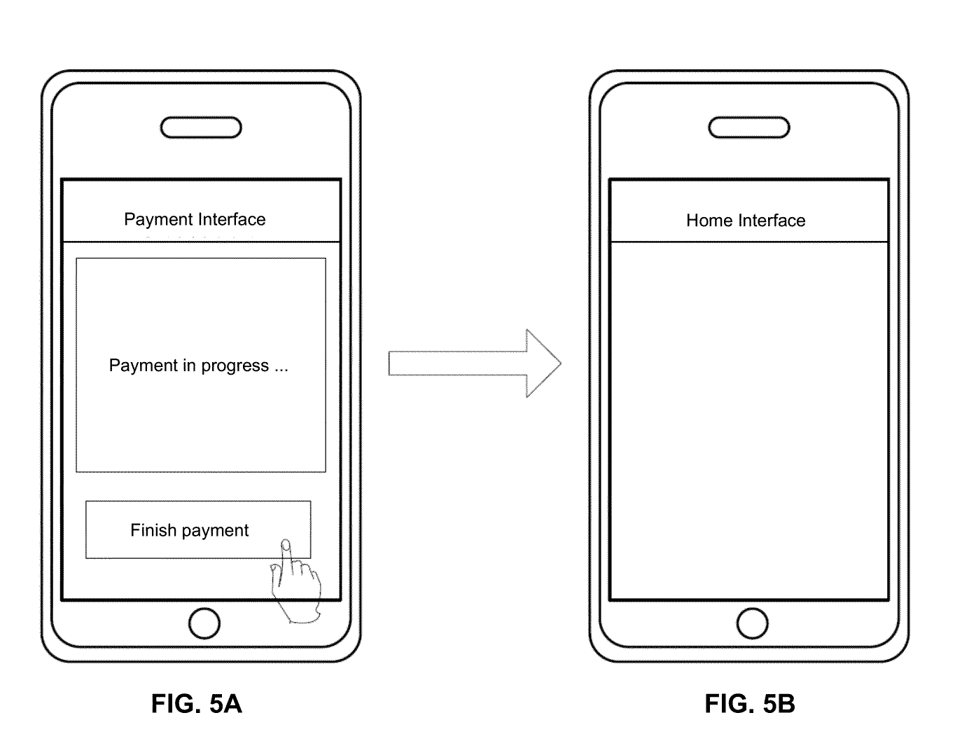

As shown in FIG. 5A, the requesting terminal displays the “Payment in progress” message to notify the user that the payment request has been submitted. At this point, the user can complete the payment process by clicking the “Finish payment” icon, triggering the submission of the payment completion request. In some embodiments, the authentication server or the payment server will not complete the payment process until after the submission of the payment completion request from the requesting terminal. This gives the user a chance to abort the payment process after submitting the payment request and the payment request is authenticated. As shown in FIG. 5B, the authentication server responds to the payment completion request by causing the requesting terminal to return to the previous browsing interface or to the home screen of the requesting terminal.

Note that the user can click the “Finish Payment” icon right after submitting the payment request without waiting for the authentication of the payment request and then quit the payment interface. In this case, the payment completion request will still be rejected if the payment authentication request fails. By doing so, the user can save time to perform other tasks using the requesting terminal, e.g., making a phone call or sending a message. Regardless of whether the payment authentication request succeeds or not, the user at the requesting terminal will be notified that the final result of the original payment request.

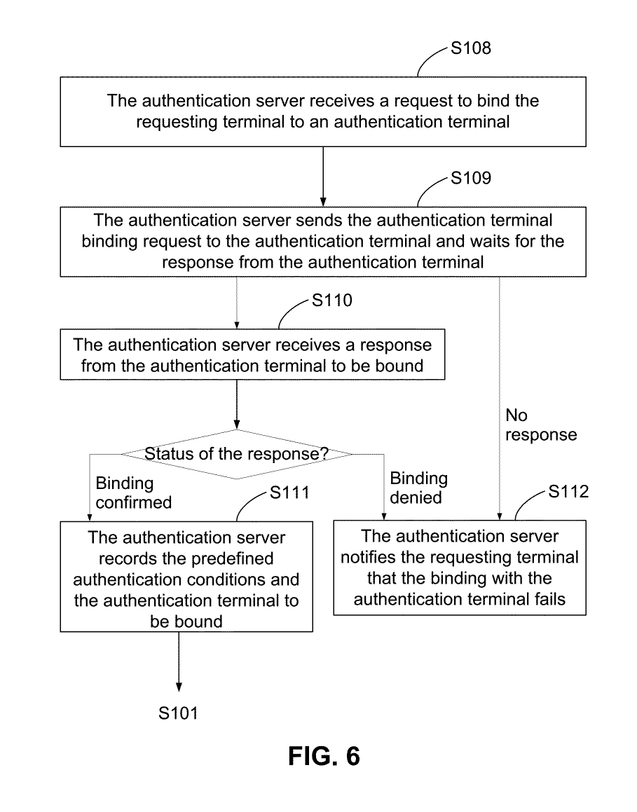

FIG. 6 depicts a third embodiment of the payment authentication method. In this embodiment, prior to the step S101, the method further comprises:

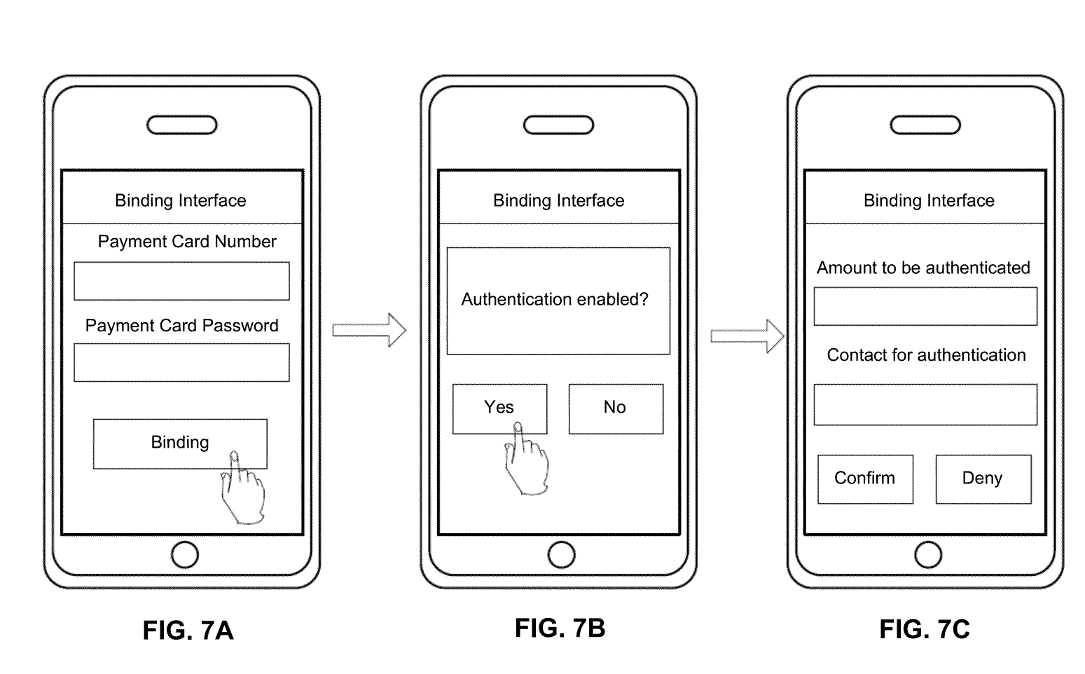

Step S108, the authentication server receives a request to bind the requesting terminal to an authentication terminal. The request includes predefined authentication conditions and the requesting terminal to be bound. Note that the request may come from the requesting terminal or another entity (e.g., a server associated with a financial institution). This binding process may happen when the requesting terminal uses a mobile payment application to bind itself to a bank account or thereafter. As shown in FIG. 7A, after entering the bank card number and password, the user clicks the “Binding” icon to complete the process of binding a bank card (i.e., a bank account) to the requesting terminal. As shown in FIG. 7B, a binding interface pops up, prompting the user whether the requesting terminal should be bound to an authentication terminal.

If the user clicks the “Yes” icon, the requesting terminal then displays the binding interface as shown in FIG. 7C. The binding interface requires the user to set the appropriate authentication conditions, such as the amount to be paid for triggering the authentication process, the user information associated with the authentication terminal, and so on. In order to ensure safety and efficiency of information transmission, the user may be chosen among friends of the user of the requesting terminal on a third-party mobile application, such as one from the contact list of an instant messaging application. When the user clicks the “Confirm” icon in FIG. 7C, the requesting terminal submits a request to bind the requesting terminal to the authentication terminal.

Step S109, the authentication server sends the authentication terminal binding request to the authentication terminal and waits for the response from the authentication terminal.

Step S110, the authentication server receives a response from the authentication terminal to be bound. This response indicates whether the authentication terminal binding request is confirmed or rejected. In order to improve the authentication binding efficiency, the authentication server may set a time window. When a time-bound response is not received within the time window, the authentication server will abandon the request and initiate a new binding request. The new binding request may include the same information as the previous one or replace it with new information, e.g., another person in the contact list at the requesting terminal.

Step S111, after the authentication terminal confirms the authentication terminal binding request, the authentication server records the predefined authentication conditions and the authentication terminal to be bound for processing subsequent payment authentication requests.

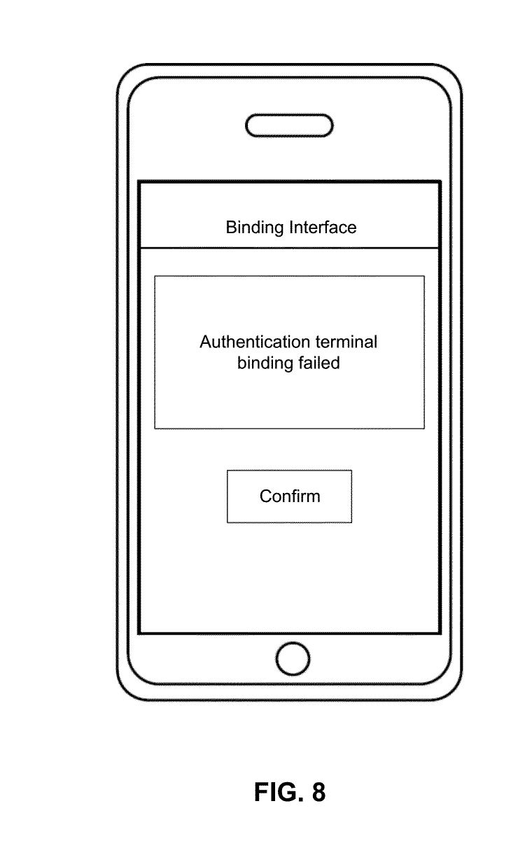

Step S112, if there is no response from the authentication terminal or the authentication terminal binding request is denied by the authentication terminal, the authentication server notifies the requesting terminal that the binding with the authentication terminal fails. In some embodiments, to improve the efficiency of binding with an authentication terminal, the authentication server sets a time window, for example one hour. If there is no response received within one hour from the authentication terminal, the authentication server notifies the requesting terminal that the binding with the authentication terminal fails as shown in FIG. 8. At this point, the user can initiate the binding process again. The new binding request may include the same information as the previous one or replace it with new information, e.g., another person in the contact list at the requesting terminal.

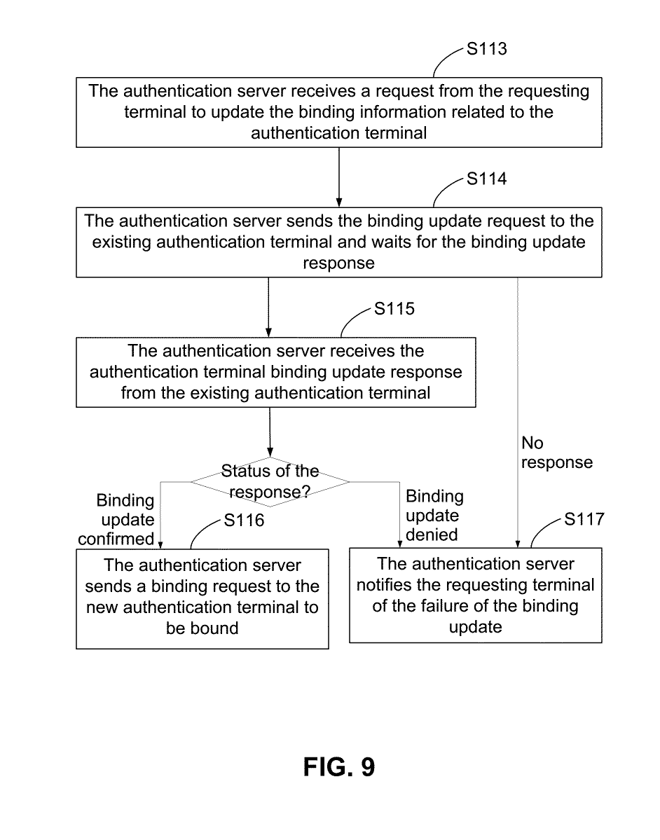

FIG. 9 depicts a payment authentication update method according to the fourth embodiment of the present application. In this embodiment, the payment authentication update method further comprises:

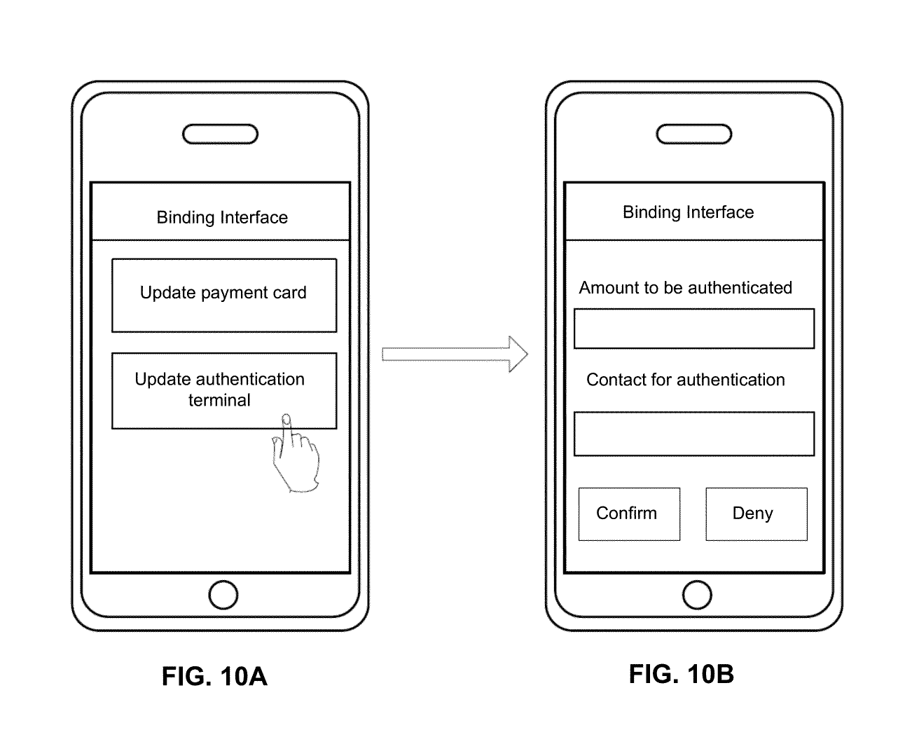

Step S113, the authentication server receives a request from the requesting terminal to update the binding information related to the authentication terminal. In some embodiments, the request includes the predefined authentication conditions, the existing authentication terminal, and the new authentication terminal to be bound. As shown in FIG. 10A, the user clicks on the “Update authentication terminal” icon, a new binding interface pops up as shown in FIG. 10B. The interface requires the user to re-set the authentication conditions and the authentication terminal, such as a new payment amount that requires authentication and a new user in the contact list. Note that the user of the requesting terminal may change only one parameter (e.g., the payment amount or the contact) and leave the other one unchanged. A user click of the “Confirm” icon triggers the requesting terminal to send the binding update information to the authentication server.

Step S114, the authentication server sends the binding update request to the existing authentication terminal and waits for the binding update response.

Step S115, the authentication server receives the authentication terminal binding update response from the existing authentication terminal. In some embodiments, the response indicates whether the binding update request has been confirmed or rejected. In order to improve the authentication binding efficiency, the authentication server may set a time window. When a time-bound response is not received within the time window, the authentication server will abandon the request and initiate a new binding update request.

Step S116, when the existing authentication terminal confirms the binding update request, the authentication server sends a binding request to the new authentication terminal to be bound. This process is similar to the one described above in connection with FIGS. 6 to 8. If the authentication terminal binding request succeeds, the authentication server then stores the updated authentication conditions and the identity of the new authentication terminal for subsequent authentication purpose and notifies the requesting terminal of the success of the authentication terminal binding update.

Step S117, when there is no response from the existing authentication terminal within the predefined time window or when the existing authentication terminal denies the binding update request, the authentication server notifies the requesting terminal of the failure of the binding update.

Since the binding update request from the requesting terminal needs to be confirmed by the existing authentication terminal, this can prevent somebody else from changing the authentication terminal unilaterally and without authorization from the existing authentication terminal and further enhance the security of making payments from the requesting mobile terminal.

Note that the authentication server described above plays the role of an intermediate server facilitating the communication between the requesting terminal and the payment server as well as the authentication terminal.

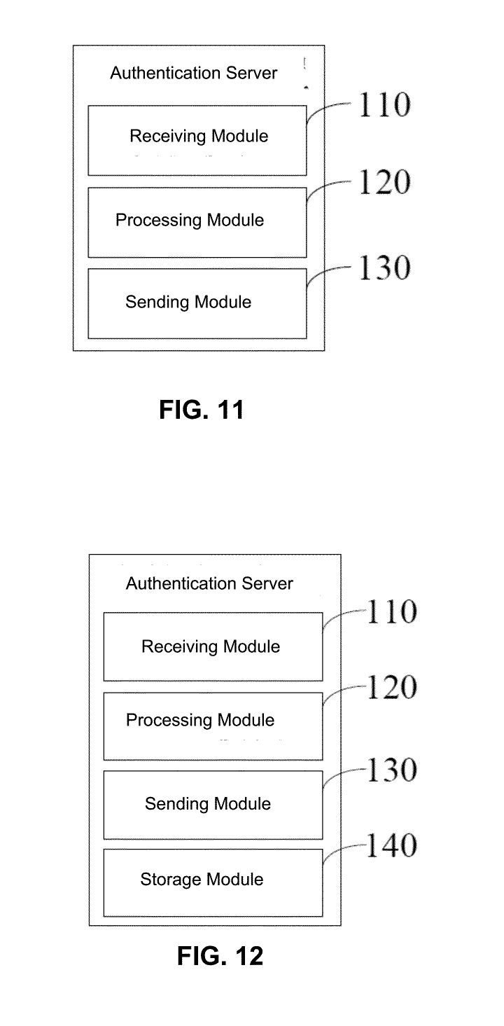

Further, some embodiments of the present application relate to a payment authentication server. Referring to FIG. 11, the payment authentication server comprises:

A receiving module 110 for receiving a payment request sent by the requesting terminal and receiving the authentication response from the authentication terminal.

A processing module 120 for determining whether the payment request satisfies predefined authentication conditions and determining whether the requesting terminal has been authenticated based on the response from an authentication terminal that has been bound to the requesting terminal.

A sending module 130 for sending a payment authentication request to the authentication terminal after the payment request satisfies the predefined authentication conditions and sending the payment request to the payment server after the authentication terminal authenticates the payment request.

The receiving module 110 and the sending module 130 are used to communicate with an external terminal or server. The receiving module 110 receives a payment request sent by the requesting terminal or an authentication response from the authentication terminal.

The payment request includes payment information, such as product information, payment amount, the source of goods and bank account information, payment password and so on. The authentication response indicates whether the payment request is confirmed or denied. The processing module 120 determines whether the payment request satisfies the predefined authentication conditions and whether the requesting terminal has been verified or not based on the response from the authentication terminal. For example, the authentication condition may be that when the payment amount exceeds a predetermined threshold (e.g., $1000), there is a need for authentication. Therefore, the sending module 130 sends the payment authentication request to the authentication terminal that has been bound to the requesting terminal.

The payment authentication request includes the information of the requesting terminal and payment details, such as product information and the amount to be paid. When the authentication terminal approves the payment authentication request, the sending module 130 sends the payment request to the payment server. When the authentication terminal denies the payment authentication request, the sending module 130 notifies the requesting terminal that the payment request failed and waits for a request from the requesting terminal to initiate the payment authentication process again.

Using the payment authentication scheme, in response to a payment request from a requesting terminal, the authentication server determines whether the payment request satisfies predefined authentication conditions and, if so, sends a payment authentication request to an authentication terminal for verifying the payment request. The authentication terminal has been previously bound to the requesting terminal for verifying certain payment requests initiated by the requesting terminal. In response to an approval from the authentication terminal, the authentication server sends the payment request to the payment server for processing the payment. If the authentication terminal denies the payment request, the authentication server then abandons the payment request. By doing so, this scheme can prevent somebody else from using the requesting terminal to make any unauthorized payment.

The receiving module 110 is further configured to receive a payment completion request from a requesting terminal. The transmitting module 130 is further configured to notify that the payment is being processed as shown in FIG. 5A and then cause the requesting terminal to quit the payment user interface as shown in FIG. 5B. After the sending module 130 sends a payment authentication request to the authentication terminal, the sending module 130 also sends a payment request response to the requesting terminal. As shown in FIG. 5A, the requesting terminal displays the “Payment in progress” message to notify the user that the payment request has been submitted. At this point, the user can complete the payment process by clicking the “Finish payment” icon, triggering the submission of the payment completion request. The receiving module 110 receives the payment completion request. In response, the processing module 120 causes the requesting terminal to quit from the payment user interface and return to the previous browsing interface or to the home screen of the requesting terminal as shown in FIG. 5B.

In some other embodiments, the user can click the “Finish Payment” icon to submit the payment completion request right after submitting the payment request without waiting for the authentication of the payment request and then quit the payment interface, which makes it more convenient and efficient for the user to make mobile payment.

Referring to FIG. 12, the authentication server further comprises a storage module 140. The receiving module 110 is further configured to receive a request to bind an authentication terminal transmitted from the requesting terminal, and receive a response to the authentication terminal binding request from the authentication terminal. The sending module 130 is also used to transmit the authentication terminal binding request to the authentication terminal to be bound. The storage module 140 is used for recording the predefined authentication conditions and the authentication terminal to be bound after the authentication terminal confirms the authentication terminal binding request. The receiving module 110 receives the authentication terminal binding request including predefined authentication conditions and the authentication terminal to be bound. This binding process may happen when the requesting terminal uses a mobile payment application to bind itself to a bank account or thereafter.

When the authentication process can bind to bind bank card terminals in the request through a third party mobile payment applications, it can be after the success of the bank card will be bound in the requesting terminal via a third-party mobile payment applications. The sending module 130 transmits the authentication terminal binding request to the authentication terminal to be bound. In response, the authentication terminal indicates whether the authentication terminal binding request has been accepted or denied. In order to improve the authentication binding efficiency, the authentication server may set a time window. When a time-bound response is not received within the time window, the requesting terminal may abandon the request and initiate a new binding request. The new binding request may include the same information as the previous one or replace it with new information, e.g., another person in the contact list at the requesting terminal. If the processing module 120 determines that the authentication terminal has been bound to the requesting terminal, the storage module 140 records the predefined authentication conditions and the authentication terminal to be bound for subsequent use. If there is no response from the authentication terminal or the authentication terminal binding request is denied by the authentication terminal, the sending module 130 notifies the requesting terminal that the binding with the authentication terminal fails.

Further, the receiving module 110 is further configured to receive a binding update request and receive a response to the binding update request from the authentication terminal, the response indicating whether the binding update request has been confirmed or rejected.

The sending module 130 sends the binding update request to the authentication terminal has been bound before. The processing module 120 is also used to record the updated authentication conditions and the identity of the new authentication terminal for subsequent authentication purpose.

Since the binding update request from the requesting terminal needs to be confirmed by the existing authentication terminal, this can prevent somebody else from changing the authentication terminal unilaterally and without authorization from the existing authentication terminal and further enhance the security of making payments from the requesting mobile terminal.

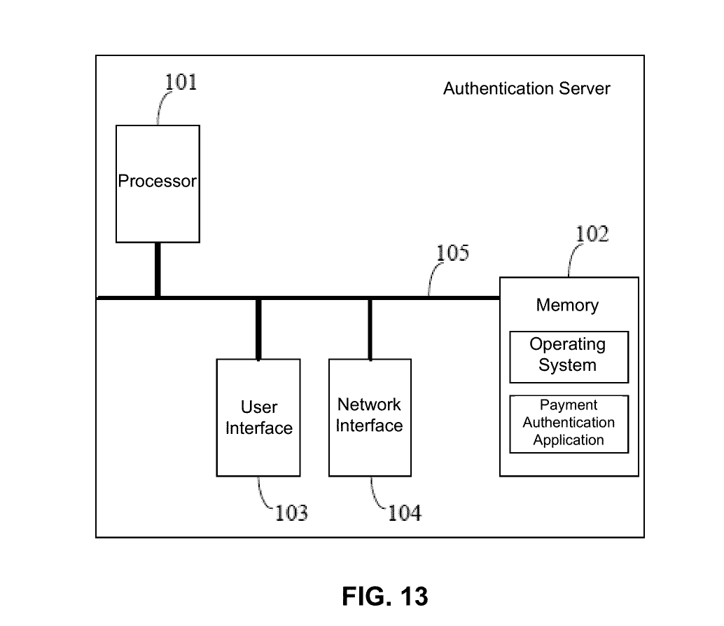

As shown in FIG. 13, the authentication server comprising: a processor 101, a memory 102, a user interface 103, a network interface 104, and a communication bus 105. The communication bus 105 is responsible for the communication between various components of the authentication server. The user interface 103 is used for receiving user input. The user interface may be a keyboard, a mouse and the like using a wired interface or a wireless interface. The network interface 104 is used for communication between the authentication server and other devices external to the server. The network interface may also include a wired interface or a wireless interface. The memory 102 may include one or more non-transitory computer-readable storage medium, and which includes not only the internal memory but also external memory. The memory stores the operating system and application supporting the payment authentication and terminal binding. The processor 101 is used to invoke the payment authentication application in the memory 102 to do the following:
Receiving a payment request from the requesting terminal through the network interface 104;
Determining whether the payment information in the payment request satisfies predefined authentication conditions;
Receiving a payment authentication response from the authentication terminal through the network interface 104;
Determining whether the requesting terminal and the payment request have been authenticated or not;
Sending the payment request to the payment server through the network interface 104 when the requesting terminal is authenticated; and
Notifying the requesting terminal through the network interface 104 that the authentication fails when the authentication terminal denies the payment request.

Further, the processor 101 is also used to invoke the payment authentication application in the memory 102 to do the following:
After sending the payment authentication request to the authentication terminal through the network interface 104 and notifying the requesting terminal via the network interface 104 that the payment request is being verified;
Receiving a request to complete the payment from the requesting terminal through the network interface 104; and
Causing the requesting terminal to quit the current payment interface in accordance with the payment completion request.

In other words, the requesting terminal can initiate the payment completion request without waiting from the authentication response from the authentication terminal and quit the current payment interface to make it more convenient and efficient.

Further, the processor 101 is also used to invoke the payment authentication application in the memory 102 to do the following:
Receiving the authentication terminal binding request from the requesting terminal through the network interface 104;
Sending a request to bind the requesting terminal to the authentication terminal via the network interface 104;
Receiving an authentication response returned by authentication terminal via the network interface 104; and
Determining whether the authentication terminal confirms or denies the authentication terminal binding request, recording the predefined authentication conditions and the authentication terminal to be bound in the memory 102 when the authentication terminal confirms the authentication terminal binding request, and notifying the requesting terminal that the authentication terminal binding request fails if there is no response from the authentication terminal or the authentication terminal binding request is denied by the authentication terminal.

Further, the processor 101 is also used to invoke the payment authentication application in the memory 102 to do the following:
Receiving a binding update request sent by the requesting terminal via the network interface 104;
Sending the binding update request via the network interface 104 to the authentication terminal that has been bound to the requesting terminal (i.e., the existing authentication terminal);
Receiving the binding update response from the authentication terminal via the network interface 104; and
Determining whether the authentication terminal has confirmed or denied the binding update request, recording the predefined authentication conditions and the new authentication terminal to be bound in the memory 102 when the existing authentication terminal confirms the binding update request, and notifying the requesting terminal that the binding update request fails if there is no response from the existing authentication terminal or the binding update request is denied by the existing authentication terminal.

Since the binding update request from the requesting terminal needs to be confirmed by the existing authentication terminal, this can prevent somebody else from changing the authentication terminal unilaterally and without authorization from the existing authentication terminal and further enhance the security of making payments from the requesting mobile terminal.

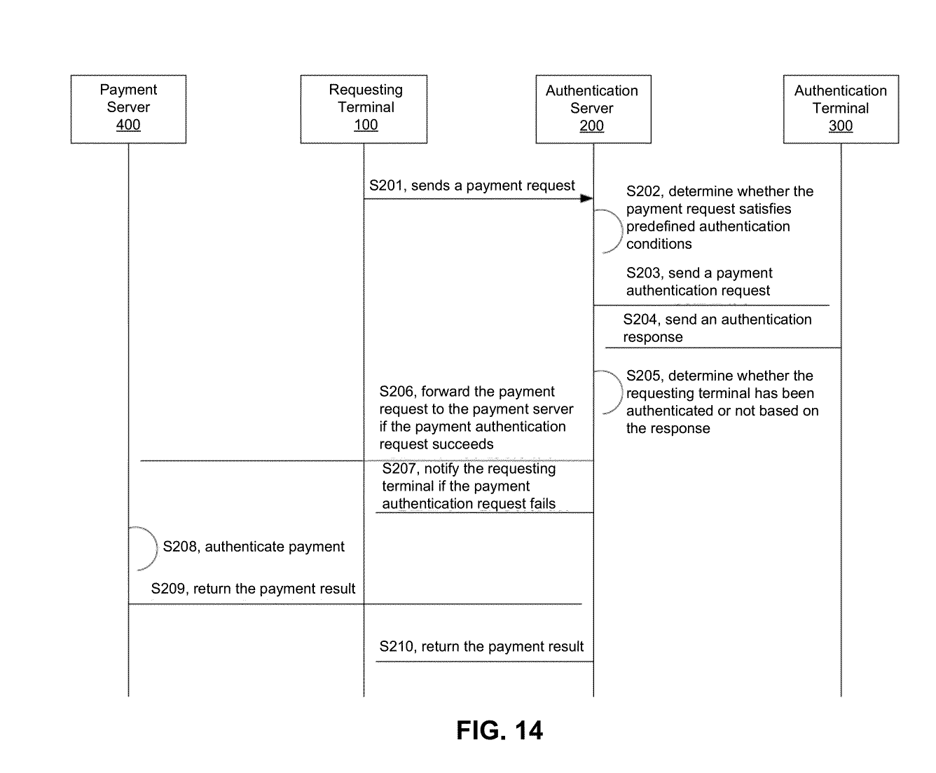

Referring to FIG. 14, the embodiment of the payment authentication method comprises the following steps of:

Step S201, the requesting terminal sends a payment request to the authentication server.

The payment request includes payment information, such as product information, payment amount, the source of goods and bank account information, payment password and so on. When a user purchases a product through a mobile terminal while browsing the product on the mobile terminal, he can click on the “Buy Now” icon as shown in FIG. 2A and enter the user interface shown in FIG. 2B. The interface asks the user to enter the bank card number and the payment password. When users enters the card number and payment password, the user then clicks the “pay” icon, which triggers a mobile payment request. Note that the product for sale is not only tangible products, but also intangible products, such as prepaid services, coupon services.

Step S202, the authentication server determines whether the payment request satisfies predefined authentication conditions.

Upon receiving the payment request sent by the requesting terminal, the authentication server determines whether the payment request satisfies predefined authentication conditions. For example, the authentication condition may be that when the payment amount exceeds a predetermined threshold (e.g., $1000), there is a need for authentication. Therefore, if the amount of the payment is $1100, the predefined condition is met and the payment needs to be verified and the server will send the payment authentication request to the authentication terminal that has been bound to the mobile terminal.

Step S203, when the payment request satisfies the predefined authentication conditions, the authentication server sends a payment authentication request to an authentication terminal that has been bound to the mobile terminal.

In some embodiments, the payment authentication request includes information of the requesting terminal (e.g., the phone number of the requesting terminal if it is a smartphone) and payment details, such as product information and the amount to be paid, etc.

Step S204, in response to the payment authentication request, the authentication terminal processes the payment authentication request and sends an authentication response to the authentication server. The response indicates whether the payment authentication request succeeds or fails.

Step S205, the authentication server determines whether the requesting terminal has been authenticated or not based on the response. If so, the authentication server proceeds to the step S206, otherwise to step S207.

Step S206, the authentication server forwards the payment request to the payment server if the payment authentication request succeeds.

Step S207, the authentication server notifies the requesting terminal if the payment authentication request fails. As shown in FIG. 3, the requesting terminal displays a message indicating that the payment authentication request fails. The requesting terminal may subsequently initiate a new payment request.

Step S208, the payment server, in response to the payment request, authenticates the payment card and payment password associated with the payment request and returns the authentication result. Note that the payment card may be one selected from the group consisting of a debit card, a credit card or a gift card.

Step S209, the payment server returns the payment result to the authentication server. After the authentication at the payment server succeeds, the payment server returns a response indicating that the payment is successful. After the authentication at the payment server fails, the payment server returns a payment failure response. The response may include reasons why the payment fails, e.g., the wrong card number or password, network timeouts, and so on.

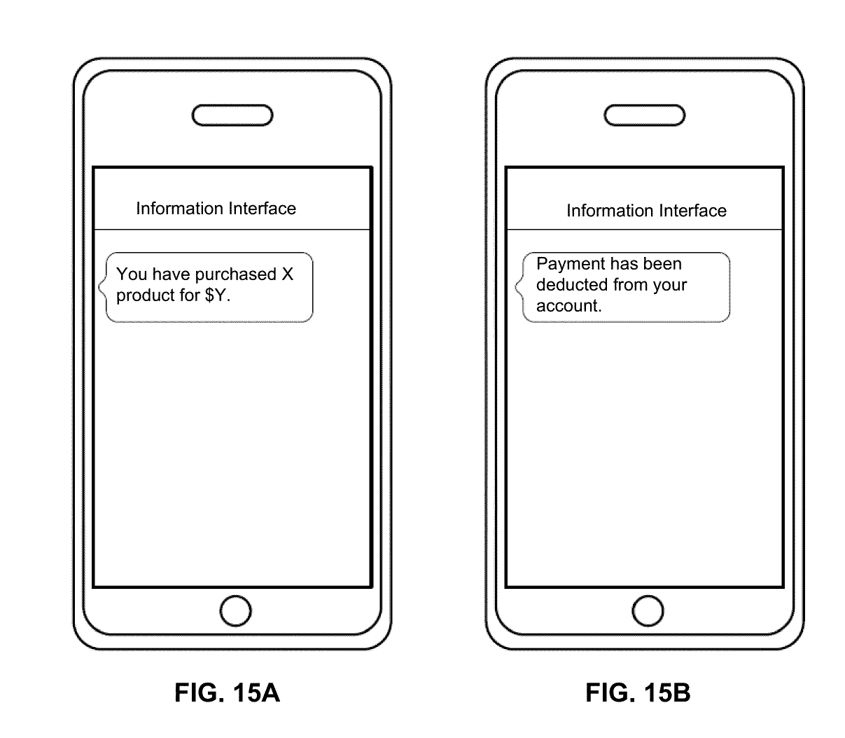

Step S210, the authentication server notifies the requesting terminal of the payment result. In other words, the payment result may indicate that the payment request succeeds or fails. As shown in FIG. 15A, the authentication server causes a message to be displayed on the requesting terminal's display, indicating that the payment is successful. In addition, the requesting terminal receives a message from the bank indicating that a certain amount of money has been deducted from the corresponding bank account, as shown in FIG. 15B.

In sum, the authentication server sends a payment authentication request to an authentication terminal that has been bound to the requesting terminal upon receipt of a payment request that meets predefined conditions. The authentication server forwards the payment request to the payment server only after the payment authentication request succeeds at the authentication terminal and rejects the payment request if otherwise. By doing so, the authentication server can prevent a lost mobile terminal from being used by somebody else for making unauthorized payments and enhance the safety of mobile payments.

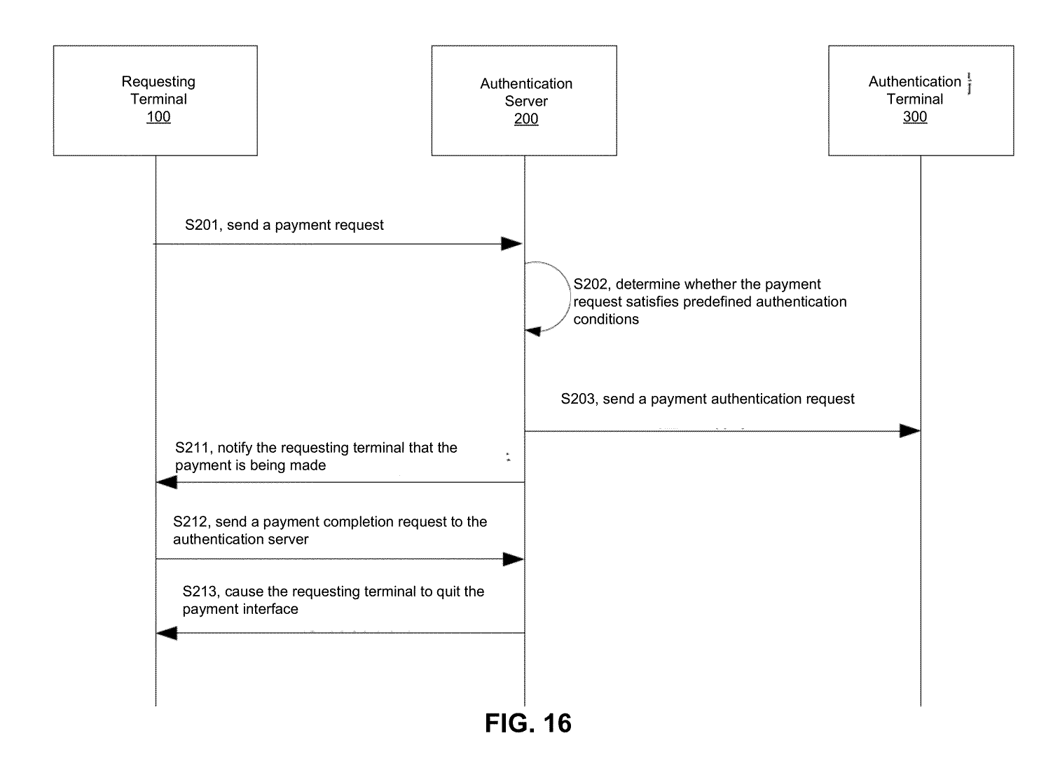

Referring to FIG. 16, this embodiment of the payment authentication method after said step S203, further comprises:

Step S211, the authentication server notifies the requesting terminal that the payment is being made.

Step S212, the requesting terminal sends a payment completion request to the authentication server.

Step S213, the authentication server, in response to the payment completion request, causes the requesting terminal to quit the payment interface. As shown in FIG. 5A, the requesting terminal displays the “Payment in progress” message to notify the user that the payment request has been submitted. At this point, the user can complete the payment process by clicking the “Finish payment” icon, triggering the submission of the payment completion request. In some embodiments, the authentication server or the payment server will not complete the payment process until after the submission of the payment completion request from the requesting terminal. This gives the user a chance to abort the payment process after submitting the payment request and the payment request is authenticated. As shown in FIG. 5B, the authentication server responds to the payment completion request by causing the requesting terminal to return to the previous browsing interface or to the home screen of the requesting terminal.

Note that the user can click the “Finish Payment” icon right after submitting the payment request without waiting for the authentication of the payment request and then quit the payment interface. In this case, the payment completion request will still be rejected if the payment authentication request fails. By doing so, the user can save time to perform other tasks using the requesting terminal, e.g., making a phone call or sending a message. Regardless of whether the payment authentication request succeeds or not, the user at the requesting terminal will be notified that the final result of the original payment request.

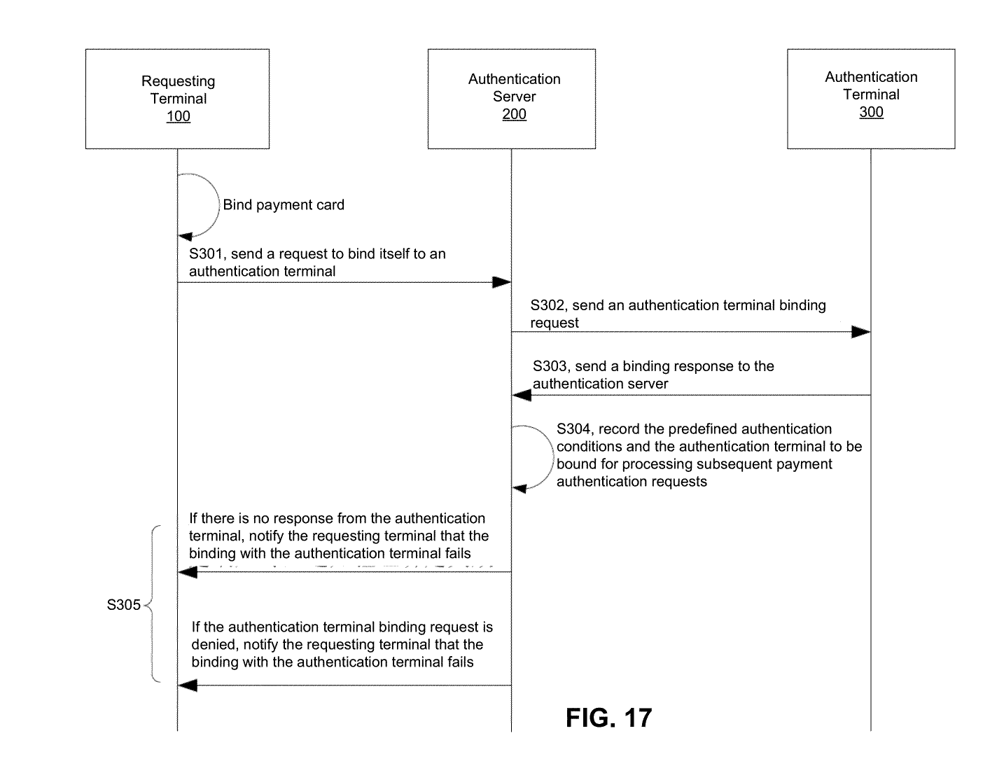

Referring to FIG. 17, this embodiment of the method of payment authentication, prior to the step S201, further comprises:

Step S301, the requesting terminal sends, to the authentication server, a request to bind itself to an authentication terminal. The binding request includes the predefined authentication conditions and the authentication terminal to be bound. Note that the request may come from the requesting terminal or another entity. This binding process may happen when the requesting terminal uses a mobile payment application to bind itself to a bank account or thereafter. As shown in FIG. 7A, after entering the bank card number and password, the user clicks the “Binding” icon to complete the process of binding a bank card (i.e., a bank account) to the requesting terminal. As shown in FIG. 7B, a binding interface pops up, prompting the user whether the requesting terminal should be bound to an authentication terminal.

If the user clicks the “Yes” icon, the requesting terminal then displays the binding interface as shown in FIG. 7C. The binding interface requires the user to set the appropriate authentication conditions, such as the amount to be paid for triggering the authentication process, the user information associated with the authentication terminal, and so on. In order to ensure safety and efficiency of information transmission, the user may be chosen among friends of the user of the requesting terminal on a third-party mobile application, such as one from the contact list of an instant messaging application. When the user clicks the “Confirm” icon in FIG. 7C, the requesting terminal submits a request to bind the requesting terminal to the authentication terminal.

Step S302, the authentication server sends an authentication terminal binding request to the authentication terminal to be bound. In some embodiments, the authentication server sends the authentication terminal binding request to a terminal associated with a contact identified by the user of the requesting terminal and waits for response from the authentication terminal.

Step S303, the authentication terminal, in response to the authentication terminal binding request, sends a binding response to the authentication server, the binding response indicating whether the authentication terminal binding request is confirmed or rejected. In order to improve the authentication binding efficiency, the authentication server may set a time window. When a time-bound response is not received within the time window, the authentication server will abandon the request and initiate a new binding request. The new binding request may include the same information as the previous one or replace it with new information, e.g., another person in the contact list at the requesting terminal.

Step S304, after the authentication terminal confirms the authentication terminal binding request, the authentication server records the predefined authentication conditions and the authentication terminal to be bound for processing subsequent payment authentication requests.

Step S305, if there is no response from the authentication terminal or the authentication terminal binding request is denied by the authentication terminal, the authentication server notifies the requesting terminal that the binding with the authentication terminal fails. In some embodiments, to improve the efficiency of binding with an authentication terminal, the authentication server sets a time window, for example one hour. If there is no response received within one hour from the authentication terminal, the authentication server notifies the requesting terminal that the binding with the authentication terminal fails as shown in FIG. 8. At this point, the user can initiate the binding process again. The new binding request may include the same information as the previous one or replace it with new information, e.g., another person in the contact list at the requesting terminal.

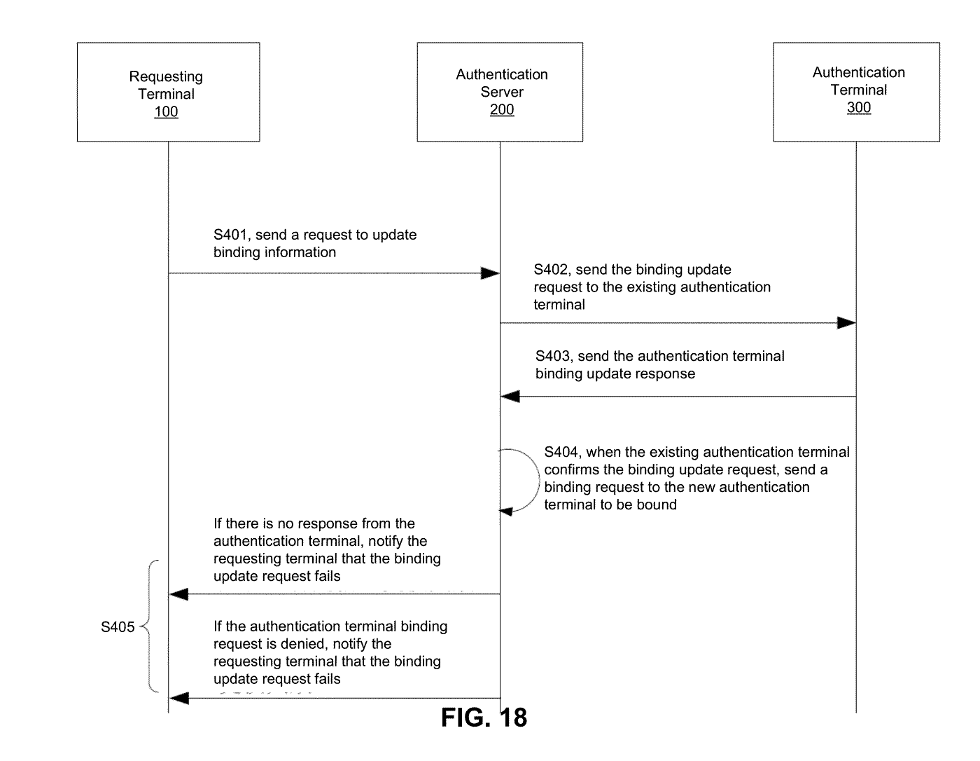

Referring to FIG. 18, this embodiment of the payment authentication method further comprises:

Step S401, the authentication server receives a request from the requesting terminal to update the binding information related to the authentication terminal. In some embodiments, the request includes the predefined authentication conditions, the existing authentication terminal, and the new authentication terminal to be bound. As shown in FIG. 10A, the user clicks on the “Update the authentication terminal” icon, a new binding interface pops up as shown in FIG. 10B. The interface requires the user to re-set the authentication conditions and the authentication terminal, such as a new payment amount that requires authentication and a new user in the contact list. Note that the user of the requesting terminal may change only one parameter (e.g., the payment amount or the contact) and leave the other one unchanged. A user click of the “Confirm” icon triggers the requesting terminal to send the binding update information to the authentication server.

Step S402, the authentication server sends the binding update request to the existing authentication terminal and waits for the binding update response.

Step S403, the authentication server receives the authentication terminal binding update response from the existing authentication terminal. In some embodiments, the response indicates whether the binding update request has been confirmed or rejected. In order to improve the authentication binding efficiency, the authentication server may set a time window. When a time-bound response is not received within the time window, the authentication server will abandon the request and initiate a new binding update request.

Step S404, when the existing authentication terminal confirms the binding update request, the authentication server sends a binding request to the new authentication terminal to be bound. This process is similar to the one described above in connection with FIGS. 6 to 8. If the authentication terminal binding request succeeds, the authentication server then stores the updated authentication conditions and the identity of the new authentication terminal for subsequent authentication purpose and notifies the requesting terminal of the success of the authentication terminal binding update.

Step S405, when there is no response from the existing authentication terminal within the predefined time window or when the existing authentication terminal denies the binding update request, the authentication server notifies the requesting terminal of the failure of the binding update. Since the binding update request from the requesting terminal needs to be confirmed by the existing authentication terminal, this can prevent somebody else from changing the authentication terminal unilaterally and without authorization from the existing authentication terminal and further enhance the security of making payments from the requesting mobile terminal.

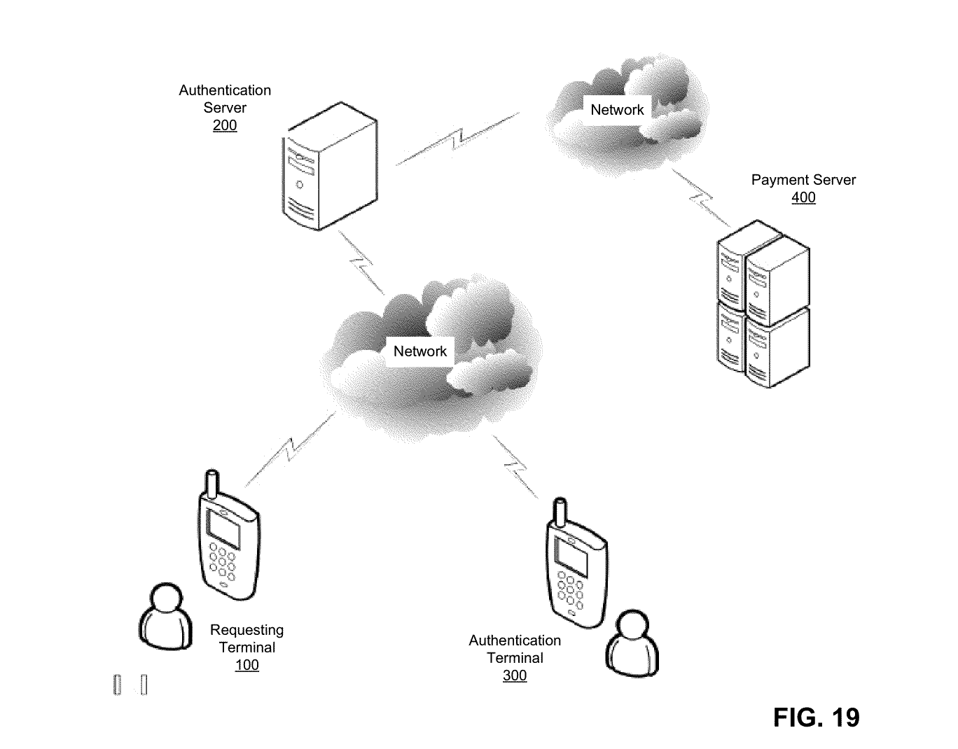

Referring to FIG. 19, the secure payment system includes a requesting terminal 100, an authentication server 200, and an authentication terminal 300. The requesting terminal 100 is responsible for transmitting a payment request to the authentication server 200. The authentication server 200 is configured to determine whether the payment request satisfies predefined authentication conditions. When the payment request satisfies predefined authentication conditions, the authentication server 200 sends a payment authentication request to the authentication terminal 300 that has been bound to the requesting terminal 100. According to the authentication response from the authentication terminal 300, the authentication server 200 determines whether the payment request has been authenticated or not and, if so, sends the payment request to the payment server 400. The authentication terminal 300 is configured to send an authentication response to the authentication server 200 in response to the payment authentication request.

In sum, the authentication server sends a payment authentication request to an authentication terminal that has been bound to the requesting terminal previously upon receipt of a payment request that meets predefined conditions. The server forwards the payment request to the payment server only after the payment authentication request succeeds at the authentication terminal and rejects the payment request if otherwise. By doing so, the authentication server can prevent a lost mobile terminal from being used by somebody else for making unauthorized payments and enhance the safety of mobile payments.

Further, the authentication server 200 is further configured to receive a payment completion request from the requesting terminal 100, notify the requesting terminal 100 of the progress of the payment request, and cause the requesting terminal 100 to quit the payment interface. Note that the user can submit the payment completion request and quit the payment interface without waiting for the response from the authentication terminal. By doing so, the user can save time to perform other tasks using the requesting terminal, e.g., making a phone call or sending a message. Regardless of whether the payment authentication request succeeds or not, the user at the requesting terminal will be notified that the final result of the original payment request.

Further, the requesting terminal 100 transmits, to the authentication server 200, a request to bind itself to the authentication terminal 300. The binding request includes the predefined authentication conditions and the authentication terminal 300 to be bound. The authentication server 200 sends a request to verify the authentication terminal binding request to the authentication terminal 300. The authentication terminal 300, in response to the authentication terminal binding request, sends an authentication terminal binding response to the authentication server 200.

After the authentication terminal 300 confirms the authentication terminal binding request, the authentication server 200 records the predefined authentication conditions and the authentication terminal 300 to be bound for processing subsequent payment authentication requests.

Further, the authentication server 200 is further configured to notify the requesting terminal 300 that the binding with the authentication terminal 300 fails if there is no response from the authentication terminal 300 within a predefined time window or the authentication terminal binding request is denied by the authentication terminal 300.

Further, the requesting terminal 100 is further configured to send a request to update the binding information to the authentication server 200. In some embodiments, the request includes the predefined authentication conditions, the existing authentication terminal, and the new authentication terminal to be bound. The authentication server 200 is also used for: receiving a request from the requesting terminal 100 to update the binding information related to the authentication terminal 300, sending the binding update request to the existing authentication terminal 300, and waiting for the binding update response. The authentication server 200 is further configured to receive the binding update response from the authentication terminal 300. The response indicates whether the binding update request has been confirmed or rejected. When the existing authentication terminal confirms the binding update request, the authentication server 200 stores the updated authentication conditions and the identity of the new authentication terminal for subsequent authentication purpose.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present application. First ranking criteria and second ranking criteria are both ranking criteria, but they are not the same ranking criteria.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the present application to the precise forms disclosed. Many modifications and variations are possible in view of the above teachings. The implementations were chosen and described in order to best explain principles of the present application and its practical applications, to thereby enable others skilled in the art to best utilize the present application and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method of authenticating a payment request from a requesting terminal, comprising:
at a computer server having one or more processors and memory storing program modules to be executed by the one or more processors:
receiving a payment request from the requesting terminal;
in accordance with determining that the payment request satisfies predefined authentication conditions, sending a payment authentication request to an authentication terminal associated with the requesting terminal;
receiving a response to the payment authentication request from the authentication terminal;
forwarding the payment request to a payment server if the response indicates that the payment authentication request succeeds; and
notifying the requesting terminal that the payment request is denied if the payment authentication request fails.

2. The method of claim 1, further comprising:
before receiving the payment request:
receiving an authentication terminal binding request, the request including a unique identifier associated with the authentication terminal and one or more predefined authentication conditions;
sending the authentication terminal binding request to the authentication terminal;
generating a payment authentication relationship between the requesting terminal and the authentication terminal based on the predefined authentication conditions if the authentication terminal binding request is confirmed by the authentication terminal within a predefined time window; and
notifying the requesting terminal that the authentication terminal binding request fails if the authentication terminal binding request is denied by the authentication terminal or if there is no response from the authentication terminal within the predefined time window.

3. The method of claim 2, further comprising:
after generating the payment authentication relationship between the requesting terminal and the authentication terminal:
receiving a binding update request, the request including a unique identifier associated with the authentication terminal and a second unique identifier associated with a second authentication terminal;
sending the binding update request to the authentication terminal;
generating and sending an authentication terminal binding request to the second authentication terminal if the binding update request is confirmed by the authentication terminal within a predefined time window; and
notifying the requesting terminal that the binding update request fails if the binding update request is denied by the authentication terminal or if there is no response from the authentication terminal within the predefined time window.

4. The method of claim 2, wherein the authentication terminal binding request is generated by and sent from a server upon receipt of a request from the requesting terminal to bind itself to a bank account associated with the server.

5. The method of claim 1, wherein the computer server sends a message to the requesting terminal after receiving the payment request, and the message causes a display of a payment in progress alert and a finish payment icon at the requesting terminal, and a user selection of the finish payment icon causes a payment completion request to be sent to the computer server.

6. The method of claim 5, wherein the computer server receives the payment completion request before receiving the response from the authentication terminal.

7. The method of claim 6, wherein the requesting terminal quits from an application through which the payment request was made after the submission of the payment completion request.

8. The method of claim 1, wherein the payment request includes product information, payment amount, bank account information, current location of the requesting terminal, and a timestamp at which the payment request was made.

9. The method of claim 1, further comprising:
after forwarding the payment request to the payment server:
receiving a payment result from the payment server; and
sending the payment result to the requesting terminal.

10. The method of claim 9, wherein the payment result indicates that the payment request is denied by the payment server.

11. A computer system, comprising:
one or more processors;
memory; and
one or more program modules to be executed by the one or more processors, the program modules including instructions for:
receiving a payment request from a requesting terminal;
in accordance with determining that the payment request satisfies predefined authentication conditions, sending a payment authentication request to an authentication terminal associated with the requesting terminal;
receiving a response to the payment authentication request from the authentication terminal;
forwarding the payment request to a payment server if the response indicates that the payment authentication request succeeds; and
notifying the requesting terminal that the payment request is denied if the payment authentication request fails.

12. The computer system of claim 11, wherein the program modules further include instructions for:
before receiving the payment request:
receiving an authentication terminal binding request, the request including a unique identifier associated with the authentication terminal and one or more predefined authentication conditions;
sending the authentication terminal binding request to the authentication terminal;
generating a payment authentication relationship between the requesting terminal and the authentication terminal based on the predefined authentication conditions if the authentication terminal binding request is confirmed by the authentication terminal within a predefined time window; and
notifying the requesting terminal that the authentication terminal binding request fails if the authentication terminal binding request is denied by the authentication terminal or if there is no response from the authentication terminal within the predefined time window.

13. The computer system of claim 12, wherein the program modules further include instructions for:
after generating the payment authentication relationship between the requesting terminal and the authentication terminal:
receiving a binding update request, the request including a unique identifier associated with the authentication terminal and a second unique identifier associated with a second authentication terminal;
sending the binding update request to the authentication terminal;
generating and sending an authentication terminal binding request to the second authentication terminal if the binding update request is confirmed by the authentication terminal within a predefined time window; and
notifying the requesting terminal that the binding update request fails if the binding update request is denied by the authentication terminal or if there is no response from the authentication terminal within the predefined time window.

14. The computer system of claim 11, wherein the payment request includes product information, payment amount, bank account information, current location of the requesting terminal, and a timestamp at which the payment request was made.

15. The computer system of claim 11, wherein the program modules further include instructions for:
after forwarding the payment request to the payment server:
receiving a payment result from the payment server; and
sending the payment result to the requesting terminal.

16. A non-transitory computer-readable storage medium storing one or more program modules to be executed by a computer system having one or more processors, the program modules including instructions for:
receiving a payment request from a requesting terminal;
in accordance with determining that the payment request satisfies predefined authentication conditions, sending a payment authentication request to an authentication terminal associated with the requesting terminal;
receiving a response to the payment authentication request from the authentication terminal;
forwarding the payment request to a payment server if the response indicates that the payment authentication request succeeds; and
notifying the requesting terminal that the payment request is denied if the payment authentication request fails.

17. The non-transitory computer-readable storage medium of claim 16, wherein the program modules further include instructions for:
before receiving the payment request:
receiving an authentication terminal binding request, the request including a unique identifier associated with the authentication terminal and one or more predefined authentication conditions;
sending the authentication terminal binding request to the authentication terminal;
generating a payment authentication relationship between the requesting terminal and the authentication terminal based on the predefined authentication conditions if the authentication terminal binding request is confirmed by the authentication terminal within a predefined time window; and
notifying the requesting terminal that the authentication terminal binding request fails if the authentication terminal binding request is denied by the authentication terminal or if there is no response from the authentication terminal within the predefined time window.

18. The non-transitory computer-readable storage medium of claim 17, wherein the program modules further include instructions for:
after generating the payment authentication relationship between the requesting terminal and the authentication terminal:
receiving a binding update request, the request including a unique identifier associated with the authentication terminal and a second unique identifier associated with a second authentication terminal;
sending the binding update request to the authentication terminal;
generating and sending an authentication terminal binding request to the second authentication terminal if the binding update request is confirmed by the authentication terminal within a predefined time window; and
notifying the requesting terminal that the binding update request fails if the binding update request is denied by the authentication terminal or if there is no response from the authentication terminal within the predefined time window.

19. The non-transitory computer-readable storage medium of claim 16, wherein the payment request includes product information, payment amount, bank account information, current location of the requesting terminal, and a timestamp at which the payment request was made.

20. The non-transitory computer-readable storage medium of claim 16, wherein the program modules further include instructions for:
after forwarding the payment request to the payment server:
receiving a payment result from the payment server; and
sending the payment result to the requesting terminal.
